(19) United States
(12) Patent Application Publication
(10) Pub. No.: US 2006/0077545 A1
(43) Pub. Date: Apr. 13, 2006

(54) Apparatus to align stereoscopic display

(75) Inventors: Joshua M. Cobb, Victor, NY (US); James E. Roddy, Rochester, NY (US)

Correspondence Address: Mark G. Bocchetti;Eastman Kodak Company, Patent Legal Staff, 343 State Street, Rochester, NY, 14650-2201, US

(73) Assignee: Eastman Kodak Company

(21) Appl. No.: 10/961,966

(22) Filed: Oct. 8, 2004

(51) Int. Cl. G02B 27/22

(52) U.S. Cl. 359/464; 359/472

(57) ABSTRACT

An alignment viewer apparatus (40) for assessing optical path alignment of a stereoscopic imaging system (10), the apparatus (40) having a left reflective surface (42l) for diverting light from a left viewing pupil (14l) toward a beam combiner (44) and a right reflective surface (42r) for diverting light from a right viewing pupil (14r) toward the beam combiner (44). The beam combiner (44) directs the diverted light from left and right viewing pupils (14l and 14r) to form a combined alignment viewing pupil (36), allowing visual assessment of optical path alignment thereby.

### FIELD OF THE INVENTION

This invention generally relates to stereoscopic display apparatus and more particularly relates to an apparatus and method for alignment of image path components in a stereoscopic display apparatus that presents spatially separate left and right images.

### BACKGROUND OF THE INVENTION

The advantages offered by stereoscopic imaging are well recognized as useful in a number of applications, including medical imaging, flight simulation, and entertainment. In stereoscopic imaging, complementary left- and right-eye images are formed separately, typically in separate left and right channels, and are presented to the viewer to provide a composite image that is perceived as having enhanced depth and as being more realistic than are images conventionally projected over a single channel.

A number of stereoscopic imaging approaches have been employed in various types of imaging systems. For example, some types of stereoscopic imaging systems use a projection screen or surface and employ special multiplexing timing or polarization techniques, requiring that the viewer wear suitable polarized glasses, shutter glasses, or other devices that enables each eye to receive its intended image. Other approaches may use head-mounted devices in which each left and right image is separately projected onto a projection surface visible to the corresponding eye of the viewer. Still other stereoscopic display devices have been developed using lenticular optical technology. In these more conventional types of stereoscopic systems, the composite stereoscopic image is formed on a surface, such as a projection screen. That is, each left and right image of such a system is formed as a real image on a display surface.

In an alternate approach, pupil imaging techniques have been used for a number of stereoscopic imaging solutions. In pupil imaging, each image of the stereoscopic image pair is presented to the viewer at a corresponding pupil location. Referring to FIG. 1, there is shown, in highly simplified form, the overall arrangement of a stereoscopic pupil imaging apparatus 10 having a left imaging channel 12l and a right imaging channel 12r. Both left imaging channel 12l and right imaging channel 12r are similarly constructed. In left imaging channel 12l, an image is formed on a left image modulator 16l, such as an liquid crystal device (LCD), organic light-emitting device (OLED), or other image-forming component. One or more lenses 18, and mirrors 20 direct modulated light from left image modulator 16l to a projection lens 22, which forms a left viewing pupil 14l at the position of the viewer's left eye. Similarly, right image modulator 16r and its supporting lenses 18 and mirror 20 in right imaging channel 12r cooperate to form, through projection lens 22, a right viewing pupil 14r. One or more adjustment mechanisms 24 are provided in each imaging channel 12l, 12r for obtaining the correct alignment of the projected images.

An early example of a pupil imaging stereoscopic system is disclosed in U.S. Pat. No. 3,447,854 (Minter). In the apparatus of the Minter '854 patent, a 3-D viewer employs a curved mirror acting as a field lens for shifting the position of the viewing pupil for separate left-eye and right-eye images. Similarly, in an article entitled “Stereoscopic Display Using a 1.2-M Diameter Stretchable Membrane Mirror” by McKay et al., a large curved mirror is used in conjunction with left and right beamsplitters for providing a real image, shifting a convergence point for left- and right-image disparity to some position along the primary optical axis relative to the curved mirror surface. Significantly, with both the Minter '854 apparatus and the McKay et al. apparatus, the projected image is focused onto the surface of the curved mirror itself. With this arrangement, since the projected image is focused onto the curved mirror; the mirror itself does not form the image, but simply directs light into the pupils of the viewer. Because the mirror serves as the display surface for this type of real image projection system, optimal viewing conditions and large field of view are obtained when using a large curved mirror placed a good distance away from the viewer.

In response to the need for more realistic autostereoscopic display solutions offering a wide field of view, commonly-assigned U.S. Pat. No. 6,416,181 (Kessler et al.), incorporated herein by reference and referred to as the Kessler et al. '181 patent, discloses an autostereoscopic imaging system using pupil imaging to display collimated left and right virtual images to a viewer. In the Kessler et al. '181 disclosure, a curved mirror is employed in combination with an imaging source, a curved diffusive surface, a ball lens assembly, and a beamsplitter, for providing the virtual image for left and right viewing pupils. Overall, the monocentric optical apparatus of the Kessler et al. '181 disclosure provides autostereoscopic imaging with large viewing pupils, a very wide field of view, and minimal aberration.

As the above description indicates, stereoscopic imaging systems can be broadly grouped into two sets, as follows:
(i) a first set of systems in which the left and right images display on the same surface; and
(ii) a second set of systems, that is, pupil imaging systems, in which the left and right images are spatially separated when presented to the left and right eyes of the viewer.

In order for realistic stereoscopic imaging in a system that minimizes eyestrain, spatial alignment of the left and right images must be obtained. For systems in this first set (i), wherein left and right images are provided on a common display surface, such as a display screen, obtaining alignment between left and right display images can be fairly straightforward. An alignment pattern for the left image can simply be projected onto the surface simultaneously with an alignment pattern for the right image. Then, discrepancies between the left and right alignment patterns can be used to assess alignment and to make adjustments that correct misalignment between left and right optical path components.

However, with pupil imaging systems in set (ii) defined above, alignment of components in left and right imaging channels proves to be much more complex. Because the left and right image paths do not overlap at any point, some method of correlating these image paths to each other must be employed. One conventional alignment approach, as shown in the block diagram of FIG. 2, is to use a pair of electronic cameras 30, one in each of the left and right imaging paths. This type of approach is used, for example, for a stereo imaging instrument as disclosed in U.S. Pat. No. 6,191,809 (Hori et al.) Images obtained from separate cameras 30 can then be merged into one display matrix by an image processor 32 and the results displayed on a monitor 34 or other display, in order that any misalignment can then be detected and corrected. While such a solution works, however, the inherent cost of an alignment system of this type is high. Moreover, supporting apparatus needed for such an arrangement constrain the usefulness of such an approach, restricting its practical use to manufacturing facility personnel only. Deployment of dual-camera alignment apparatus of this type for servicing equipment in the field would be prohibitively costly.

Another approach in a pupil imaging system is to view the left and right test target images sequentially, either by closing or blocking each eye alternately, or by presenting the image first to one eye and then to the other. Although special test equipment is not needed, this method suffers from two drawbacks. First, there can be angular perception differences between any two observers, so that one observer may judge overlaid images to be aligned while a second observer see a distinct misalignment. Second, even with a single observer, there can be some amount of creep over time with angular pointing between the two eyes. Due to this phenomena, for example, two overlaid images may at first seem to be aligned, but appear to have drifted apart over a period of seconds. Due to physical visual effects such as these, the use of camera-based instrumentation, such as is shown in FIG. 2, may seem more appropriate where alignment of left and right channels is critical.

Certainly, the use of a dual camera system like that of FIG. 2 eliminates uncertainties due to human factors. However, such an approach requires precision alignment of both cameras to each other, and requires that both cameras remain aligned as they are moved to scan the full field of view. Or, if both cameras can view the whole field without being moved, then their respective magnifications must be exactly matched in order to sense proper registration. Significantly, dual camera systems can also require dual monitors, which can be bulky and expensive, or must use an image processing device such as a video mixer to display both images on a single monitor.

Thus, it can be seen that there is a need for an alignment apparatus and method for stereoscopic pupil imaging systems that is inexpensive and compact, and yet provides the needed information for making appropriate alignment adjustments for left and right imaging path components.

### SUMMARY OF THE INVENTION

It is an object of the present invention to provide an improved alignment apparatus and method for alignment that address the needs given in the background section above. With this object in mind, the present invention provides an apparatus for assessing optical path alignment of a stereoscopic imaging system, the apparatus comprising:
a) a left reflective surface for diverting light from a left viewing pupil toward a beam combiner;
b) a right reflective surface for diverting light from a right viewing pupil toward the beam combiner; and
c) the beam combiner directing the diverted light from left and right viewing pupils to form a combined viewing pupil, thereby allowing visual assessment of optical path alignment.

It is a feature of the present invention that it uses a beam combiner for overlaying left and right images at a single viewing pupil.

It is an advantage of the present invention that it requires a small set of components and can be easily and inexpensively fabricated. No power connection or cabling would be required for its use.

It is a further advantage of the present invention that it is easy to use, enabling an operator to assess and make adjustments quickly.

It is a further advantage of the present invention that viewer-to-viewer eye angular position differences and angular drift between eyes with a single viewer are eliminated, because only one eye is used.

It is a further advantage of the present invention that, because it does not require dual cameras, it is relatively inexpensive to implement and avoids alignment and magnification matching problems inherent to dual-camera systems.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic block diagram showing basic components of a pupil-forming stereoscopic imaging apparatus;

FIG. 2 is a schematic block diagram showing components of an alignment apparatus for assessing alignment adjustments to a pupil-forming stereoscopic imaging apparatus;

FIG. 3 is a schematic block diagram showing an apparatus for assessing spatial alignment of left and right images according to the present invention;

FIG. 4 is a perspective view of an alignment apparatus according to the present invention;

FIG. 5 is a schematic block diagram showing an apparatus for visually assessing spatial alignment of left and right images according to the present invention;

FIG. 6 is a plan view showing the appearance of typical left and right alignment images, in their separate imaging paths and when overlaid according to the present invention; and

FIG. 7 is a schematic block diagram showing an apparatus for assessing spatial alignment of left and right images using automated mechanisms according to the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

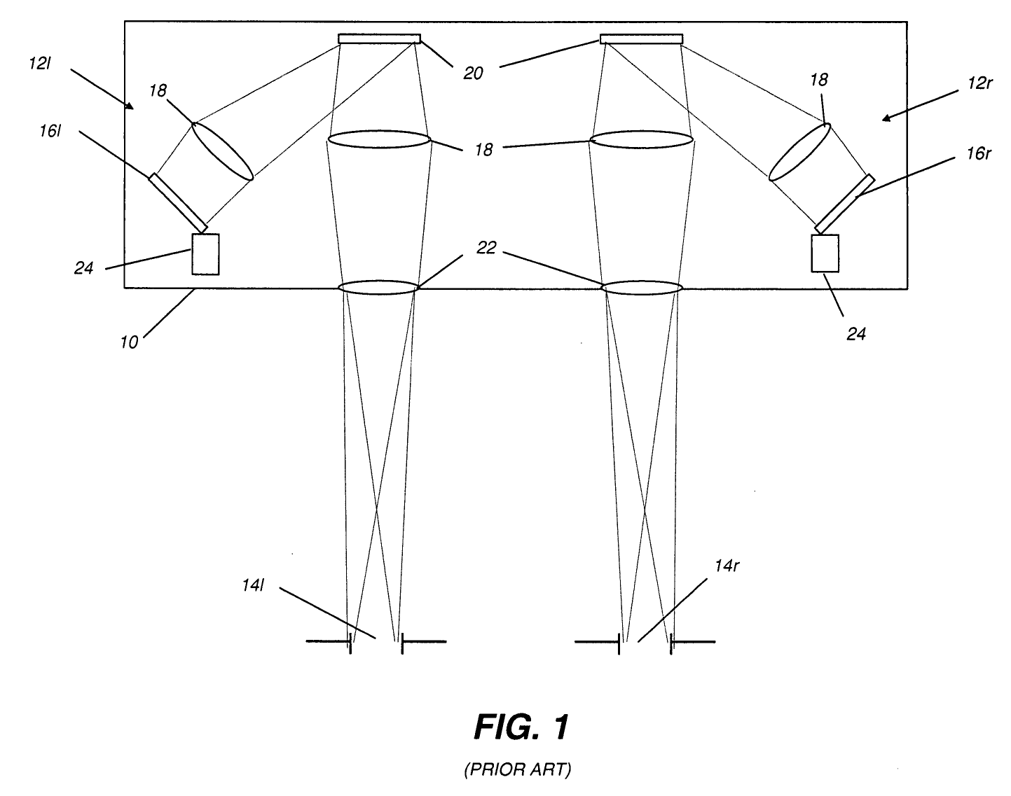

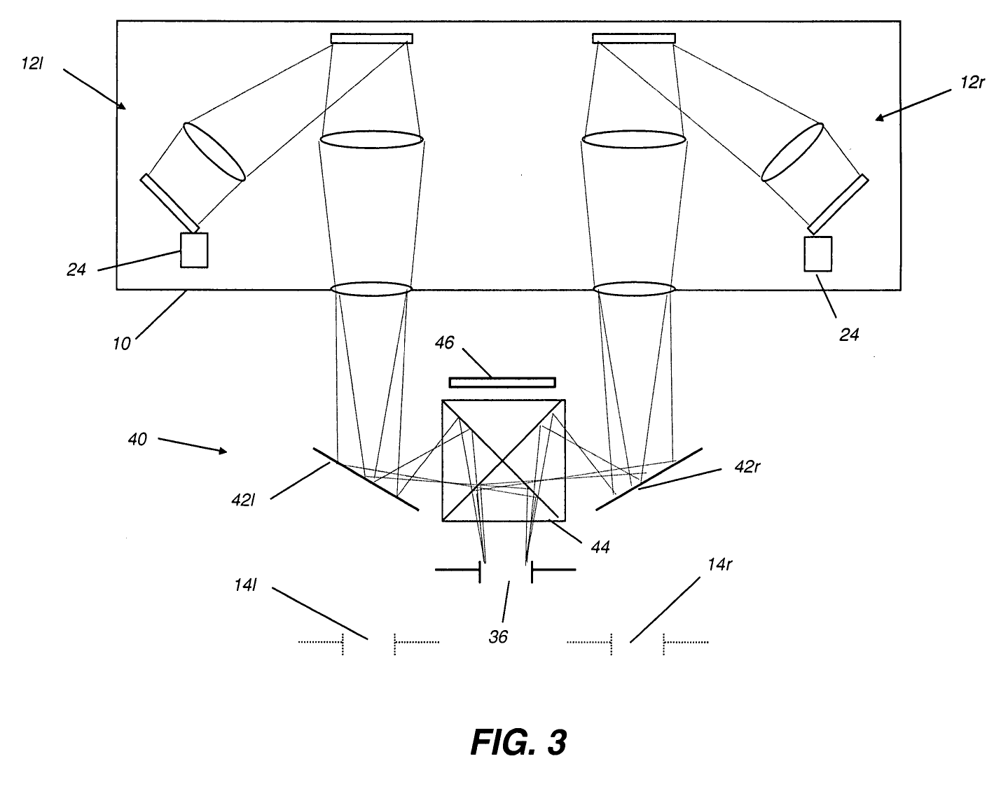

As was described with reference to FIG. 1, stereoscopic pupil imaging apparatus 10 forms left and right viewing pupils 14l and 14r at the position of the viewer. FIG. 3 shows an embodiment of the present invention in which an alignment viewer apparatus 40 redirects or diverts the light that had been projected to form left and right viewing pupils 14l and 14r (shown in phantom in FIG. 3) in order to form an alignment viewing pupil 36. Alignment viewing pupil 36 is thus formed by the combined modulated light from both left and right imaging channels 12l and 12r. A left mirror 42l directs light from left imaging channel 12l toward a beam combiner 44. Similarly, a right mirror 42r directs light from left imaging channel 12l toward a beam combiner 44. The resulting output beam from beam combiner 44 forms alignment viewing pupil 36.

In one embodiment, beam combiner 44 is an X-cube or similar component that uses a combination of dichroic surfaces for redirecting light of various wavelengths. A number of types of suitable dichroic prisms are manufactured by Optec S. R. L., Italy, for example. Dichroic prisms provide combinations of dichroic surfaces between prisms, cemented together in arrangements such as in the familiar X-cube or X-prism, Philips prism, and related devices. Different types of dichroic prisms are described, for example, in U.S. Pat. No. 6,229,651 (Edlinger), U.S. Pat. No. 6,238,051 (Huang), and U.S. Pat. No. 6,019,474 (Doany et al.) The conventional X-cube presents a first surface reflective to light in a range of red wavelengths and, orthogonally disposed to this first surface, a second surface reflective to light in a range of blue wavelengths. A baffle 46 is needed to obstruct unwanted light in the green wavelengths from entering the X-cube beam combiner 44 on a base 48.

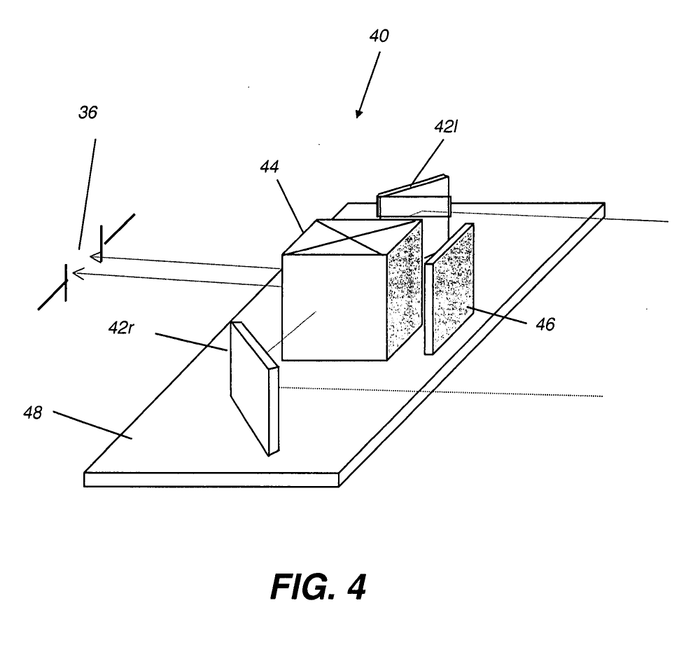

Referring to FIG. 4, there is shown a perspective view of components of alignment viewer apparatus 40. Conventional mechanical mounts, well known to those skilled in the optical arts but not depicted in FIG. 4, are used to maintain components of alignment viewer apparatus 40 in position in one embodiment. Various adhesives and other mounting methods could alternately be employed for assembly of alignment viewer apparatus 40.

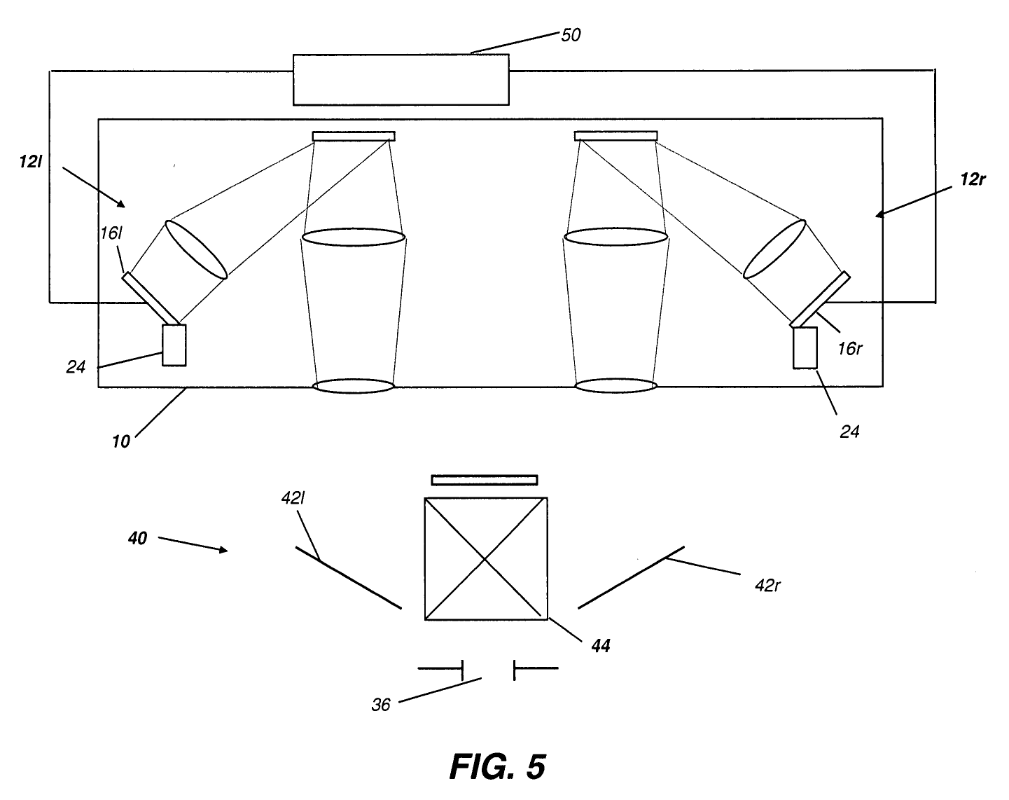

In order to use alignment viewer apparatus 40, it is necessary to provide some type of suitable image to both left and right imaging channels 12l and 12r. As is shown in the embodiment of FIG. 5, the alignment images are generated from data provided by an image pattern generator 50. In another embodiment, equivalent alignment images may simply be provided using the same image processing components that provide image data to left image modulator and right image modulator 16l and 16r in normal operation. For example, an “alignment mode” could be provided in the imaging control logic of stereoscopic pupil imaging apparatus 10, whereby a special alignment pattern could be projected from left and right imaging channels 12l and 12r. Optionally, a separate test fixture could be employed for providing alignment images, such as might be used during factory assembly of optical components within left and right imaging channels 12l and 12r, for example.

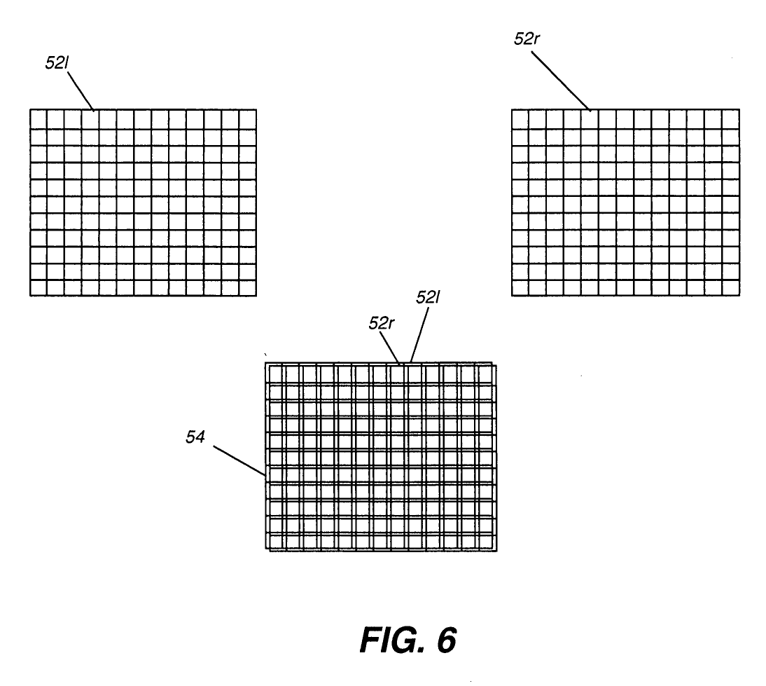

Image pattern generator 50, or its equivalent, may provide any of a number of possible alignment images to left and right imaging channels 12l and 12r. Referring to FIG. 6, there are shown simple grid patterns used for left image pattern 52l and right image pattern 52r. A combined image pattern 54, the overlap of left image pattern 52l and right image pattern 52r, is formed at alignment viewing pupil 36. The relative relationship of left image pattern 52l and right image pattern 52r can then be assessed by viewing at alignment viewing pupil 36 and adjustments made using any of the various types of adjustment mechanisms 24 provided in stereoscopic pupil imaging apparatus 10. Other types of image patterns that could be used could include reticles, grids, moire swept frequency patterns, and various patterns designed to show optical aberrations, for example.

Not visible from FIG. 6, but obvious to those familiar with X-cube optics, is the advantage that the different color paths of the X-cube provide for assessing alignment accuracy. Depending upon X-cube orientation, the image from one of left and right imaging channels 12l or 12r follows the red light path; the other image then follows the path favoring blue light. Thus, the image from each imaging channel 12l, 12r has a distinctive color. This simplifies the adjustment task, enabling one of image patterns 52l or 52r to serve as a reference, while the other can be adjusted. In addition, because color identifies each light path, distortion in each imaging path can be quickly assessed, using appropriately designed image patterns.

Adjustment mechanism 24 could be any of a number of types of mechanical devices used to adjust the spatial or angular position of one or more components in left and right imaging channels 12l or 12r. Adjustment mechanisms 24 could be electronically controlled devices, such as motors or piezoelectric actuators, for example, or could be manually adjustable screws or similar devices. Alternately, particularly where spatial misalignment is on the order of a pixel or more, alignment compensation could be achieved using image manipulation techniques that effectively “re-map” the spatial location of pixels, correcting for misalignment of left and right imaging channels 12l or 12r by changes to pixel addressing for one or more pixel locations on left or right image modulators 16l or 16r.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, alignment viewer apparatus 40 could be used with any type of stereoscopic pupil imaging apparatus 10 that provides left and right viewing pupils 14l and 14r, providing either virtual or real images. Images for stereoscopic pupil imaging apparatus 10 can be generated using any of a wide range of devices serving as left and right image modulators 16l and 16r, including LCD or digital micromirror device spatial light modulators, organic light-emitting diode (OLED) devices including polymer organic light-emitting diode (PLEDs), or scanned electromechanical grating light modulators such as grating light valve (GLV) or GEMS devices (electromechanical conformal grating devices, as described in U.S. Pat. No. 6,307,663 (Kowarz), for example.) Any of a number of possible adjustment mechanisms 24 could be used to correctly adjust the position of left and right image modulators 16l and 16r or other components in left and right imaging channels 12l and 12r within stereoscopic pupil imaging apparatus 10.

The design of alignment viewer apparatus 40 admits any of a number of variations in types of components used. For example, the function of one or both of left and right mirrors 42l and 42r could be provided more generally by a reflective surface of some type, such as by a properly oriented prism or a beamsplitter, for example. While use of an X-cube as beam combiner 44 has particular advantages for identifying each imaging channel 12l, 12r by color, as noted above, other types of beam combiners 44 could be used. Typically, beam combiner 44 uses some arrangement of dichroic surfaces, similar in function to the dichroic surfaces within the X-cube. Alignment viewer apparatus 40 could be provided as a ruggedized assembly, inexpensively produced and easily usable by factory test or field personnel.

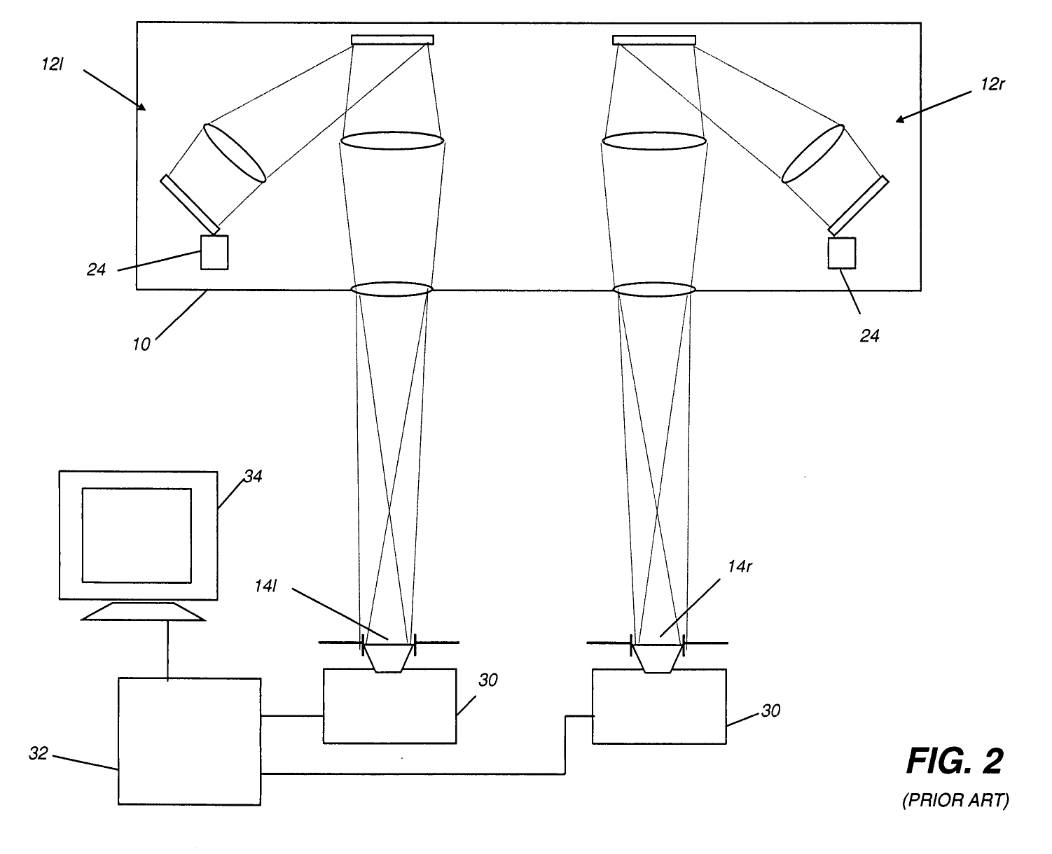

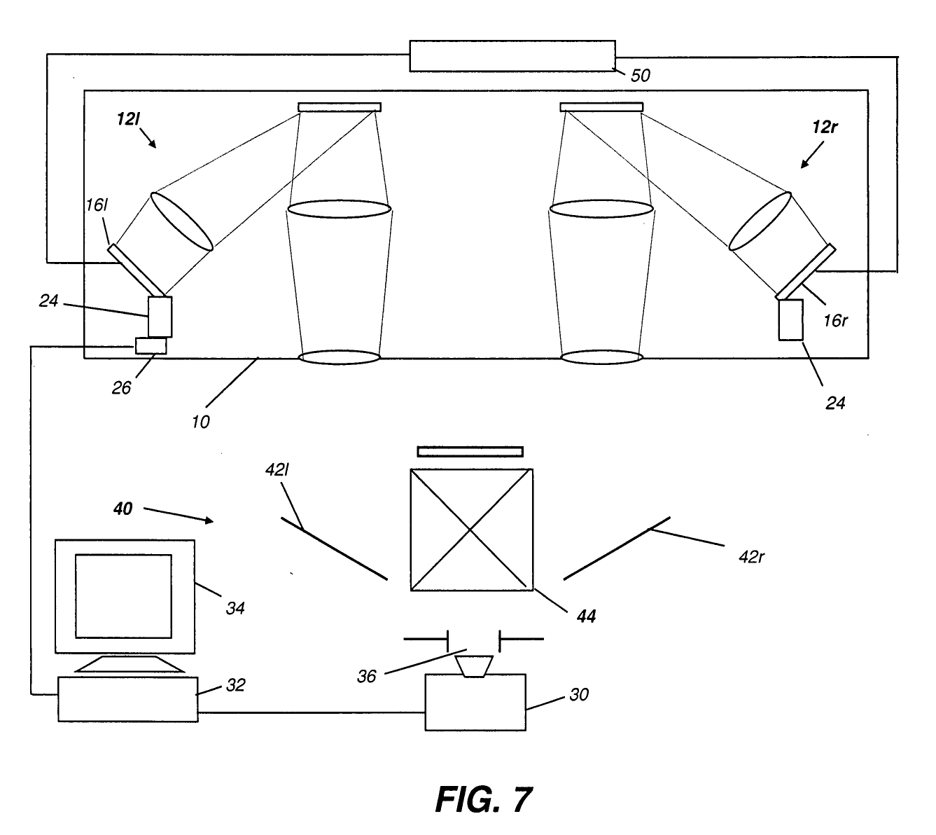

In may be desirable, especially in an assembly operation, to combine the mirror/prism apparatus shown in FIG. 4 with a single color camera, or other suitable type of image sensor, and monitor. Referring to the block diagram of FIG. 7, electronic camera 30 used for alignment purposes would be positioned at alignment viewing pupil 36. Electronic camera 30 could have a zoom feature to provide additional magnification that allows careful scrutiny of the alignment, and a dual gimbal mount that allows the camera/mirror/prism assembly to scan the field of view without “walking out” of alignment viewing pupil 36. Such a single electronic camera 30 would not require critical alignment and could maintain its alignment within alignment viewing pupil 36 while scanning the field of view. Because only a single electronic camera 30 would be required, there would be no need for precise magnification, as with dual-camera systems, as was described with reference to FIG. 2. The embodiment of FIG. 7 could be used simply to display electronic camera 30 output at monitor 34 or to provide some type of displayed or printed output. Alternately, in a more automated embodiment using the basic arrangement shown in FIG. 7, electronic camera 30 could be used to provide input to image analysis software executing on image processor 32 that determines alignment of left and right image patterns 52l, 52r (as represented in FIG. 6). The use of a single-color camera 30 or similar single-color sensor device allows a relatively inexpensive embodiment; camera 30 could also be color-sensing. A number of possible types of sensing components could be used to provide the function of camera 30 as described hereinabove, including charge-coupled devices (CCDs), CMOS sensors, and other sensor types, provided with suitable supporting optics.

In a more elaborate arrangement, a control loop could then be devised for automating the relative adjustment of components in left and right imaging channels 12l, 12r. Control logic, executing on image processor 32 or on some other computing platform, in cooperation with image analysis software, could control an actuator 26 that adjusts the position of a component in left or right imaging channel 12l, 12r, using techniques well known in the machine control arts. Alternately, control logic, in cooperation with image analysis software, could be used to control a spatial pixel re-mapping to compensate for misalignment, as described hereinabove.

Thus, what is provided is an apparatus and method for alignment of image path components in a stereoscopic display apparatus that present spatially separate left and right images.

### Parts List

10 stereoscopic pupil imaging apparatus
12l left imaging channel
12r right imaging channel
14l left viewing pupil
14r right viewing pupil
16l left image modulator
16r right image modulator
18 lens
20 mirror
22 projection lens
24 adjustment mechanism
26 actuator
30 electronic camera
32 image processor
34 monitor
36 alignment viewing pupil
40 alignment viewer apparatus
42l left mirror
42r right mirror
44 beam combiner
46 baffle
48 base
50 image pattern generator
52l left image pattern
52r right image pattern
54 combined image pattern

1. An apparatus for assessing optical path alignment of a stereoscopic imaging system, the apparatus comprising:
a) a left reflective surface for diverting light from a left viewing pupil toward a beam combiner;
b) a right reflective surface for diverting light from a right viewing pupil toward the beam combiner; and
c) the beam combiner directing the diverted light from left and right viewing pupils to form a combined viewing pupil, allowing visual assessment of optical path alignment thereby.

2. An apparatus according to claim 1 wherein the beam combiner is an X-cube.

3. An apparatus according to claim 1 wherein the beam combiner comprises an arrangement of dichroic surfaces.

4. An apparatus according to claim 1 wherein the left reflective surface is a mirror.

5. An apparatus according to claim 1 wherein the left reflective surface is a surface of a prism.

6. An apparatus according to claim 1 wherein the left reflective surface is a beamsplitter.

7. An apparatus according to claim 1 further comprising an image generator providing a left test pattern to a left image-forming light modulator and providing a right test pattern to a right image-forming light modulator.

8. A system for assessing optical path alignment of a pupil-forming stereoscopic imaging apparatus, the system comprising:
a) an image generator providing a left test pattern to a left image-forming light modulator and providing a right test pattern to a right image-forming light modulator;
b) a left reflective surface for diverting modulated light away from a left viewing pupil and toward a beam combiner;
c) a right reflective surface for diverting modulated light away from a right viewing pupil and toward the beam combiner; and
d) the beam combiner directing the diverted light from left and right viewing pupils to form a combined viewing pupil for assessment of the optical path alignment using the overlaid left and right test patterns.

9. A system according to claim 8 further comprising a sensor disposed proximate the combined viewing pupil for obtaining an image comprising combined left and right test patterns.

10. A system according to claim 9 further comprising a logic processor for analyzing the obtained image.

11. A system according to claim 9 further comprising a display monitor for displaying the obtained image.

12. A system according to claim 8 wherein the beam combiner is an X-cube.

13. A system according to claim 8 wherein the beam combiner comprises an arrangement of dichroic surfaces.

14. A system according to claim 8 wherein the left reflective surface is a mirror.

15. A system according to claim 8 wherein the left reflective surface is a surface of a prism.

16. A system according to claim 8 wherein the left reflective surface is a beamsplitter.

17. A system according to claim 8 wherein the sensor is a camera.

18. A system for assessing optical path alignment of a pupil-forming stereoscopic imaging apparatus, the system comprising:
a) an image generator providing a left test pattern to a left image-forming light modulator and providing a right test pattern to a right image-forming light modulator;
b) a left reflective surface for diverting modulated light away from a left viewing pupil and toward a beam combiner;
c) a right reflective surface for diverting modulated light away from a right viewing pupil and toward the beam combiner;
d) the beam combiner directing the diverted light from left and right viewing pupils to form a combined viewing pupil; and
e) a sensor disposed proximate the combined viewing pupil for obtaining an image comprising combined left and right test patterns.

19. A system according to claim 18 further comprising a logic processor for analyzing the obtained image.

20. A system according to claim 18 further comprising a display monitor for displaying the obtained image.

21. A system according to claim 18 wherein the beam combiner is an X-cube.

22. A system according to claim 18 further comprising a logic controller for controlling an actuator according to the obtained image, the actuator adjusting the position of at least one optical component in the image generator.

23. A system according to claim 18 wherein the sensor is a camera.

24. A system according to claim 18 wherein the beam combiner comprises an arrangement of dichroic surfaces.

25. A method for assessing optical path alignment of a stereoscopic imaging system, comprising:
a) forming a left test pattern at a left image-forming light modulator of the stereoscopic imaging system and forming a right test pattern at a right image-forming light modulator of the stereoscopic imaging system;
b) diverting light from a left viewing pupil toward a beam combiner;
c) diverting light from a right viewing pupil toward a beam combiner; and
d) combining the diverted light from left and right viewing pupils to form a combined viewing pupil for visual assessment of the optical path alignment.

26. A method according to claim 25 further comprising the step of disposing a sensor proximate the combined viewing pupil for obtaining an image comprising the left and right test patterns.

27. A method according to claim 26 further comprising the step of controlling an actuator in an optical path within the stereoscopic imaging system according to the test pattern image obtained.

28. A method according to claim 25 wherein the step of diverting light from the left viewing pupil toward a beam combiner comprises the step of directing light toward an X-cube.
